(19) United States
(12) Patent Application Publication
(10) Pub. No.: US 2021/0095979 A1
(43) Pub. Date: Apr. 1, 2021

(54) SELECTIVELY COALESCING STOP LOCATIONS OF ROUTE OPTIONS IN A DYNAMIC TRANSPORTATION MATCHING SYSTEM

(71) Applicant: Lyft, Inc., San Francisco, CA (US)

(72) Inventors: Alexander Michael Weinstein, Seattle, WA (US); David Halsted Riege, San Francisco, CA (US); Maksim Rozentsveyg, New York, NY (US)

(21) Appl. No.: 16/586,567

(22) Filed: Sep. 27, 2019

(51) Int. Cl. G01C 21/34; G06Q 50/30

(52) U.S. Cl. CPC G01C 21/3438; G01C 21/3453; G06Q 50/30; G01C 21/3446

(57) ABSTRACT

The present disclosure relates to systems, non-transitory computer-readable media, and methods for selectively coalescing stop locations of route options in a dynamic transportation matching system. In one or more embodiments, the coalescing controller system generates route scores for driving route options, including route scores for an optimal non-coalesced driving route option and a coalesced driving route option. In some embodiments, the route score can include a driving score, a walking score, and a coalescing factor. Based on the route scores, the coalescing controller system can determine to coalesce stop locations. For example, if the route score of the coalesced driving route option is lower than the non-coalesced driving route option, the coalescing controller system can determine to coalesce stop locations in accordance with the coalesced driving route option. Additionally, the coalescing controller system can send instructions to a transportation provider device in accordance with the coalesced driving route option.

### BACKGROUND

In recent years, popularity and usage of on-demand transportation matching systems have significantly grown. Indeed, the proliferation of web and mobile applications easily enable requesting individuals to request transportation from one geographic area to another geographic area. For instance, an on-demand transportation matching system receives transportation requests and pairs the requests with providers that can transport requesting individuals to destination locations. In addition, the on-demand transportation matching system provides tools to providers to pick up requesting individuals as well as transport them to the destination locations.

Additionally, on-demand transportation matching systems can provide shared transportation for individuals, in which the individuals share a transportation vehicle with each other. While shared transportation can be more efficient in some respects, shared transportation can often result in other system complexities and inefficiencies and/or user inefficiencies. For instance, sharing a single transportation vehicle among multiple individuals can introduce an increased number of stop locations, increasingly inefficient driving routes to pick up and/or drop off one or more additional individuals, etc. In addition, different transportation modes having different user requirements and options for the requesting individual can create additional system variables, resulting in increased computational overhead and system complexity.

Some on-demand transportation matching systems attempt to decrease system complexity by enabling a shared transportation mode only for requesting individuals of a same transportation mode. In these or other cases, some on-demand transportation matching systems can designate local stop-location hubs that are positionally fixed. Still further, in some cases, on-demand transportation matching systems can combine stop locations for multiple requestors, but these systems do so inefficiently (e.g., in a static manner irrespective of real-time assessments) and/or without regard to user efficiency or user experience.

These and other problems exist with conventional transportation matching systems.

### SUMMARY

This disclosure describes one or more embodiments of methods, non-transitory computer readable media, and systems that solve the foregoing problems in addition to providing other benefits. While this summary refers to systems for simplicity, the summary also applies to certain disclosed methods and non-transitory computer readable media. To solve the foregoing and other problems, the disclosed systems receive transportation requests from requestor devices associated with corresponding requestors. The disclosed systems can then generate route scores for each driving route option. For example, the disclosed systems can generate a first route score for a first driving route option that includes a first stop location for a first requestor and a second stop location for a second requestor. In addition, the disclosed systems can generate a second route score for a second driving route option that includes a coalesced stop location for both the first requestor and the second requestor. Based on the route scores (e.g., the first route score and the second route score), the disclosed systems can selectively determine to coalesce stop locations. Furthermore, the disclosed systems can send instructions to a transportation provider device associated with a transportation provider in accordance with the second driving route option with the coalesced stop location.

Additional features and advantages of one or more embodiments of the present disclosure will be set forth in the description which follows.

### BRIEF DESCRIPTION OF THE DRAWINGS

The detailed description refers to the drawings briefly described below.

FIG. 1 illustrates a block diagram of an environment for implementing a transportation matching system in accordance with one or more embodiments.

FIG. 2 illustrates a schematic diagram of a process for selectively determining to coalesce stop locations in accordance with one or more embodiments.

FIG. 3A illustrates a map diagram of example thresholds for consideration of coalescing in accordance with one or more embodiments.

FIG. 3B illustrates a map diagram for selectively determining to coalesce stop locations in accordance with one or more embodiments.

FIGS. 4A-4D illustrate schematic diagrams for selectively determining to coalesce stop locations in accordance with one or more embodiments.

FIG. 5 illustrates a schematic diagram for selectively determining to coalesce stop locations in accordance with one or more embodiments.

FIG. 6 illustrates a schematic diagram for selectively determining to coalesce stop locations in accordance with one or more embodiments.

FIG. 7 illustrates a map diagram for selectively determining to coalesce stop locations in accordance with one or more embodiments.

FIGS. 8A-8B illustrate schematic diagrams for generating driving route options in accordance with one or more embodiments.

FIG. 9 illustrates a schematic diagram of a coalescing controller system in accordance with one or more embodiments.

FIG. 10 illustrates a flowchart of a series of acts in a method of selectively determining to coalesce stop locations in accordance with one or more embodiments.

FIG. 11 illustrates a block diagram of an example computing device in accordance with one or more embodiments.

FIG. 12 illustrates an example network environment of a transportation matching system in accordance with one or more embodiments.

### DETAILED DESCRIPTION

One or more embodiments of the present disclosure include a coalescing controller system of a dynamic transportation matching system that selectively determines to coalesce stop locations (e.g., for requestors requesting shared transportation for at least a portion of a trip between a request/pickup location and a destination/drop-off location). More specifically, the coalescing controller system uses route scores representing a type of cost metric for providers to drive a given route option and for one or more requestors to walk to certain stop locations along a given route option. Based on the route scores, the coalescing controller system can determine whether to coalesce stop locations. Thus, the coalescing controller system can perform dynamic evaluations in real-time to select optimal combinations of shared riders (requestors) and optimal corresponding driving routes and walking routes.

In more detail, the coalescing controller system receives a set of transportation requests in a given time window (e.g., a batching window). With the set of transportation requests, the coalescing controller system can generate route scores for various combinations of requestors associated with the transportation requests. The coalescing controller system can also consider multiple driving route options for one or more of the various combinations of requestors. For example, the coalescing controller system can consider driving route options for a first combination of requestors ABC, a second combination of requestors DE, a third combination of requestors FGH, a fourth combination of requestors ACD, a fifth combination of requestors CEF, and so forth. Within each of these possible example combinations of requestors, the coalescing controller system can consider a host of driving route options and generate associated route scores for each driving route option.

To generate route scores for a given combination of requestors, the coalescing controller system considers a driving score and a walking score for each driving route option. The lower the driving score and the walking score are, the more efficient and/or cost-effective a driving route option is. In particular, the coalescing controller system can consider a set of candidate stop locations with respect to each requestor who is eligible to walk based on the transportation mode (e.g., a mode indicating that the requestor is willing to walk some distance) specified in the transportation request.

Using the set of candidate stop locations for each requestor in a given combination of requestors who is eligible to walk, the coalescing controller system can generate corresponding route scores. In turn, the coalescing controller system can select a first driving route option with an optimal route score for the given combination of requestors that includes one of the candidate stop locations. In the first driving route option, the coalescing controller system may not coalesce one or more stop locations. Rather, the coalescing controller system can use the first driving route option as a baseline for comparison to a second driving route option that coalesces one or more stop locations for the given combination of requestors.

Specifically, if the route score for the first driving route option is lower than a route score for the second driving route option, then the coalescing controller system may determine not to coalesce one or more stop locations in accordance with the first driving route option. Conversely, if the route score for the first driving route option is higher than the route score for the second driving route option, then the coalescing controller system can determine to coalesce one or more stop locations in accordance with the second driving route option. Based on the selected driving route option, the coalescing controller system can then send instructions to one or both of a transportation provider device associated with a provider and a requestor device associated with a requestor.

As previously mentioned, the coalescing controller system described herein provides advantages over conventional transportation matching systems. In particular, the coalescing controller system described in the present disclosure can reduce computational overhead by comparing an optimal non-coalesced driving route option with a coalesced driving route option. Rather\ than perform expensive cross-analyses between all non-coalesced driving routes and coalesced driving routes, the coalescing controller system can select the optimal non-coalesced driving route option as a baseline for comparison with a limited number of coalesced driving route options. In so doing, the coalescing controller system can perform various computations faster and/or in real-time with increased system bandwidth by intelligently limiting the number of potential options needed to identify an optimal driving route.

In addition, the coalescing controller system can increase flexibility and compatibility among different transportation modes. For example, where some requestors are eligible to walk and other requestors are not eligible to walk (e.g., for pick-up and/or drop-off), the coalescing controller system can nonetheless efficiently handle the different variables introduced with multi-mode transportation options by utilizing one or more thresholds (e.g., threshold distances and threshold ETAs) and candidate stop locations. Additionally, by dynamically assessing relationships between candidate stop locations for walking-eligible requestors and stop locations for walking-ineligible requestors, the coalescing controller system can determine an optimal driving route option for transporting requestors of different transportation modes. Further, in some embodiments, the increased compatibility between different transportation modes allows the coalescing controller system to combine or increase pool sizes of transportation requests affording greater opportunities for improved match efficiencies of providers and requestors. Additionally or alternatively, the coalescing controller system can make adjustments on-the-fly to efficiently add requestors along a transportation route.

Furthermore, the coalescing controller system can also significantly simplify transportation routes by decreasing a number of stop locations and/or providing more efficient paths of travel. Specifically, by analyzing candidate stop locations for determining an optimal non-coalesced driving route option and comparing with one or more coalesced driving route options as described in this disclosure, the coalescing controller system can optimize in real-time a route for transporting requestors. In particular, the coalescing controller system optimizes the route by considering efficiency and/or cost-effectiveness for both providers and requestors. That is, the coalescing controller system also accounts for user experience and can alleviate what would have previously been multiple pick-ups and drop-offs at nearby locations that often cause time delays, increased stress, and overall negative user experiences. The coalescing controller system can also alleviate negative user experiences associated with walking-eligible requestors walking too far.

Additional features and advantages of one or more embodiments of the present disclosure are outlined in the description which follows.

As illustrated by the foregoing discussion, the present disclosure utilizes a variety of terms to describe features and advantages of the coalescing controller system. Additional detail is now provided regarding these and other terms used herein. For example, as used herein, the term “route score” refers to a type of cost metric or resource allocation metric. In particular, the route score can include a metric for providers to drive a given route option (e.g., a driving score) and for one or more requestors to walk to certain stop locations along a given route option (e.g., a walking score). As an example, the route score can include a rate card cost reflective of time and/or distance for providers to drive a given route option and for one or more requestors to walk to certain stop locations along a given route option. As an additional example, the route score can include and/or represent a time, a distance, and/or a number of actions necessary to complete a given driving route option. Furthermore, a route score can incorporate a combination of the foregoing and/or other aspects associated with a given route option.

Relatedly, as used herein, the term “coalescing factor” refers to a numerical element such as a coefficient, variable, constant, etc. In particular, the coalescing factor includes a value or multiplier for weighting a driving route option by reducing a route score according to the number of stop locations that are coalesced in the weighted driving route option. For example, a driving route option that coalesces two stop locations thereby reducing the number of stop locations by one may include a coalescing factor of (1·x); a driving route option that coalesces three stop locations thereby reducing the number of stop locations by two may include a coalescing factor of (2·x); a driving route option that coalesces four stop locations thereby reducing the number of stop locations by three may include a coalescing factor of (3·x); and so forth.

As further used herein, the term “driving route option” refers to a possible path of travel for both requestors and a provider in completing multiple transportation requests. In particular, the driving route option can include a possible driving path of a vehicle associated with one of the provider devices for navigating to and/or from pick-up/drop-off locations (i.e., stop locations among the candidate stop locations where one or more requestors can be picked up and/or dropped off by the transportation provider). Furthermore, a driving route option can indicate necessary travel by one or more requestors to or from one or more stop locations (pickup or drop-off locations). Related to stop locations, the term “coalesced stop location” as used herein refers to a combined stop location for multiple requestors (e.g., a combined pickup location for two requestors or a combination of a pickup location for one requestor and a drop-off location for another requestor). As indicated above, in some cases at least one of the requestors additionally travels to and/or from the coalesced stop location. For example, the coalescing controller system may instruct a requestor that selected a transportation mode indicating that the requestor is willing to walk to a stop location (a “walking-eligible requestor”) to walk to the coalesced stop location (e.g., a pick-up location also associated with another requestor).

Additionally related, the term “candidate stop locations” as used herein refers to a set of stop locations. In particular, the candidate stop locations can include a set of possible stop locations, to/from which a requestor may walk for pickup or drop-off. Candidate stop locations can include a curb-side location, a street corner, a venue entrance/exit, or any other potential locations where requestors might be picked up or dropped off. In addition, candidate stop locations (or more specifically, a pickup location and a drop-off location) are not necessarily request locations or destinations, respectively, given some requestors are eligible to walk from a request location to a pickup location and/or walk from a drop-off location to a destination.

As also referred to herein, the term “transportation request” refers to a communication associated with a request to be transported from one geographic location to another geographic location. In particular, the transportation request can include data associated with a requestor device and the requested transportation, including a request location (e.g., a location from which the transportation request is initiated), a pickup location (e.g., a location selected by a requestor for pickup), a destination (e.g., a location to which the requestor wishes to travel), profile information, a requestor rating, a travel history, a search history, etc.

As further referred to herein, the terms “distance” or “threshold distance” refer to a distance value, whether measured, estimated, predicted, determined, inferred, considered a constant value, or otherwise obtained. In particular, the threshold distance can include a driving distance threshold or a walking distance threshold. For example, the coalescing controller system can determine if coalescing stop locations is an option based on whether two or more stop locations are within a threshold distance of each other. Relatedly, as used herein, the terms “ETA,” “threshold ETA” or “threshold estimated time to arrival” refer to a time-based value, whether measured, estimated, predicted, determined, inferred, considered a constant value, or otherwise obtained. In particular, the threshold ETA can include an amount of time to drive or walk to a geographic area. For example, the coalescing controller system can determine if coalescing stop locations is an option based on whether two or more stop locations are within a threshold ETA.

As further referred to herein, the term “batching window” refers to a time-frame spanning some value of time. In particular, the batching window includes an amount of time during which the coalescing controller system receives transportation requests and pools one or more of the transportation requests together for matching with a provider and/or combining together.

In addition, the term “geographic area” can refer to a geohash (including any level of geohash like a geohash-5, a geohash-6, etc.) or any combination of multiple geohashes (e.g., a neighborhood or region comprising multiple geohashes).

Further, as used herein, the term “optimal” or “optimize” should be interpreted to mean “improved,” “enhanced” or “local optima,” and not necessarily as “absolute optima,” “true optimization” or the “best,” although an “absolute optima” or “best” may still be covered by the present disclosure. For example, an optimization process may improve upon a solution that was there previously, may find the best solution, or may verify that an existing solution is a “local optima” or an “absolute optima” and thus should not be modified or changed.

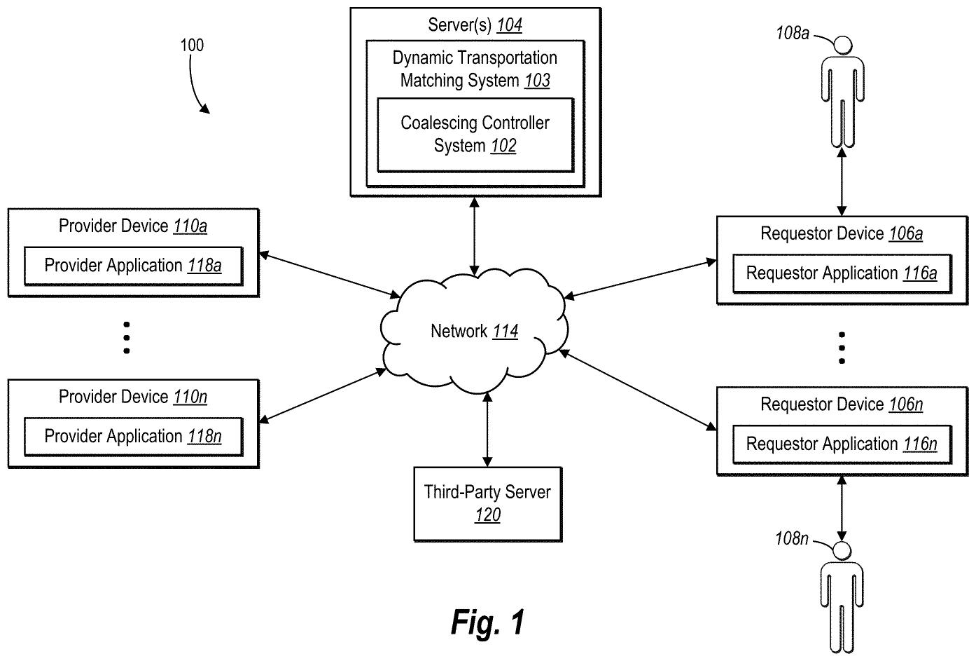

Turning to the figures, FIG. 1 illustrates an example environment 100 for a coalescing controller system 102 that selectively determines to coalesce stop locations in a dynamic transportation matching system 103, in accordance with one or more embodiments of the present disclosure. As illustrated, the environment 100 includes server(s) 104, requestor devices 106a-106n associated with requestors 108a-108n, provider devices 110a-110n, a network 114, and a third-party server 120.

As further shown, in one or more embodiments, the coalescing controller system 102 can be a component of the dynamic transportation matching system 103 implemented on one or more server(s) 104. In these or other embodiments, the coalescing controller system 102 may perform one or more acts of the present disclosure described in conjunction with the dynamic transportation matching system 103. Additionally or alternatively, the dynamic transportation matching system 103 may perform one or more acts of the present disclosure described in conjunction with the coalescing controller system 102. Furthermore, although FIG. 1 depicts the coalescing controller system 102 and the dynamic transportation matching system 103 as distinct systems, the coalescing controller system 102 can be implemented in whole or in part by the dynamic transportation matching system 103, and vice-versa. As further shown in FIG. 1, provider devices 110a-110n communicate with the coalescing controller system 102 via a network 114.

In one or more embodiments, the network 114 shown in FIG. 1 may include one or more networks and may use one or more communication platforms or technologies suitable for transmitting data and/or communication signals. In one or more embodiments, the network 114 includes a cellular network. The network 114 can additionally include the Internet or World Wide Web. Additionally or alternatively, the network 114 can include various other types of networks that use various communication technologies and protocols, such as a corporate intranet, a virtual private network (“VPN”), a local area network (“LAN”), a wireless local network (“WLAN”), a wide area network (“WAN”), a metropolitan area network (“MAN”), or a combination of two or more such networks.

FIG. 1 illustrates that the server(s) 104 includes the dynamic transportation matching system 103. In one or more embodiments, the dynamic transportation matching system 103 receives transportation requests from the requestor devices 106a-106n via requestor applications 116a-116n and provides a generated transportation match to the provider devices 110a-110n and/or an associated vehicle via provider applications 118a-118n. In particular, one or more of the provider applications 118a-118n may be a web application, a native application installed on one or both of the provider device 110a-110n or a device physically integrated with a vehicle (e.g., a mobile application, a car interface application, a desktop application, etc.), and/or a cloud-based application where part of the functionality is performed by the server(s) 104. The provider applications 118a-118n can present or display information to a provider, including digital content for accessing, receiving from, or sending information to one or both of the dynamic transportation matching system 103 or the coalescing controller system 102. A vehicle associated with any of the provider devices 110a-110n can transport the requestors 108a-108n associated with the requestor devices 106a-106n to a location specified in the transportation request.

Similar to the provider applications 118a-118n, one or more of the requestor applications 116a-116n may be a web application, a native application installed on one or both of the requestor devices 106a-106n, and/or a cloud-based application where part of the functionality is performed by the server(s) 104. The requestor applications 116a-116n can present or display information to the requestors 108a-108n, including digital content for accessing, receiving from, or sending information to one or both of the dynamic transportation matching system 103 or the coalescing controller system 102.

As further shown in FIG. 1, the environment 100 includes the third-party server 120. The third-party server 120 may include a remote server or a third-party server for obtaining data. For example, the third-party server 120 may include a Google® server from which the coalescing controller system 102 requests Google® Maps data (e.g., estimated time to arrival data for driving/walking from location to location). In other embodiments, the third-party server 120 may include a remote server for performing one or more processes described in the present disclosure (e.g., in parallel with or independent of processes performed by the coalescing controller system 102 and/or the dynamic transportation matching system 103).

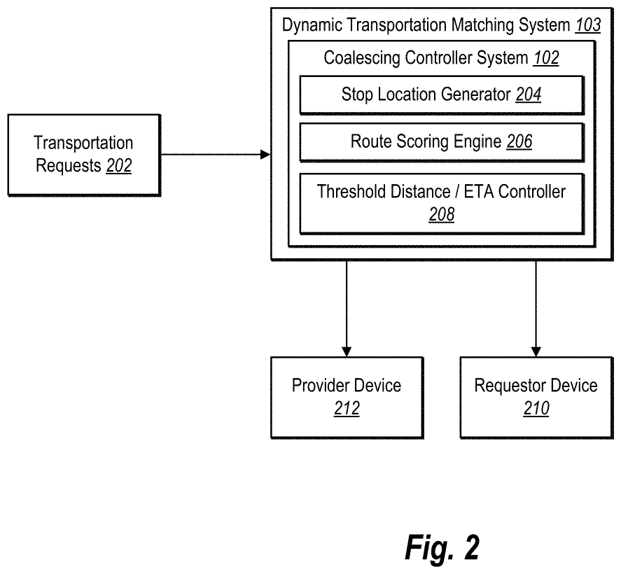

As mentioned above, the coalescing controller system 102 can receive a set of transportation requests in a given batching window and then generate route scores for various combinations of requestors associated with the transportation requests. FIG. 2 illustrates various aspects of processes associated with these and other embodiments. In particular, FIG. 2 illustrates a schematic diagram by which the coalescing controller system 102 determines to coalesce stop locations and send corresponding instructions to a requestor device 210 and a provider device 212, arranged in accordance with one or more embodiments of the present disclosure. In these or other embodiments, the requestor device 210 and the provider device 212 may be the same as or similar to the requestor devices 106a-106n and the provider devices 110a-110n, respectively, of FIG. 1 described above. Further, the coalescing controller system 102 may perform one or more acts of FIG. 2 described in conjunction with the dynamic transportation matching system 103. Additionally or alternatively, the dynamic transportation matching system 103 may perform one or more acts of FIG. 2 described in conjunction with the coalescing controller system 102.

As shown, FIG. 2 depicts inputs of transportation requests 202 received at the coalescing controller system 102 and/or the dynamic transportation matching system 103. In some embodiments, the coalescing controller system 102 receives the transportation requests 202, and then the coalescing controller system 102 can pool the transportation requests 202 according to one or more batching windows. Additionally or alternatively, the coalescing controller system 102 can receive or otherwise sort the transportation requests 202 based on a relative proximity to each other (e.g., proximity to a request location and/or a destination provided in the transportation requests 202).

Once the transportation requests 202 are received at the coalescing controller system 102, the coalescing controller system 102 can analyze various combinations of the transportation requests 202 for generating driving route options. For instance, using the above-mentioned example, the coalescing controller system 102 can consider driving route options for a set of transportation requests corresponding to requestors A-H, which may include some or all of the transportation requests 202 received at the coalescing controller system 102. In particular, the coalescing controller system 102 can consider driving route options for a first combination of requestors ABC, a second combination of requestors DE, a third combination of requestors FGH, a fourth combination of requestors ACD, a fifth combination of requestors CEF, and so forth.

In generating driving route options, the coalescing controller system 102 in some embodiments performs preprocessing techniques to reduce the transportation requests 202 to a subset of the transportation requests 202. For example, the coalescing controller system 102 may filter out a transportation request of the transportation requests 202 for which the pick-up location or the drop-off location is outside of a borough, city-limit, county, state, etc. Additionally or alternatively, the coalescing controller system 102 may filter out a transportation request of the transportation requests 202 for which the pick-up location or the drop-off location is not proximate to other transportation requests 202 and/or generally entails a directional bearing away from other transportation requests 202.

Given a set (e.g., a subset) of the transportation requests 202, the coalescing controller system 102 can utilize a stop location generator 204 to generate candidate stop locations near a pick-up location and/or a drop-off location for eligible requestors of the requestors 108a-108n (i.e., for requestors eligible to walk to and/or from a stop location). In some embodiments, the candidate stop locations are within a walking radius of a pick-up/drop-off location (e.g., a walking radius of about 300 meters, a walking radius of about 400 seconds, etc.). Additionally or alternatively, the stop location generator 204 may generate a first set of candidate stop locations and then filter one or more of the candidate stop locations in the first set to generate a second set of candidate stop locations. For example, the stop location generator 204 may filter out stop locations that initially include medians, alleys, side streets, highways, venues, clustered stop locations, dangerous areas, illegal areas, and other possibly unsuitable areas for picking up and/or dropping off the requestors 108a-108n. Additional reasons for filtering out stop locations can include a walking time greater than some amount of time (e.g., five minutes), a provider arriving early, time increases, cost increases, non-sensical implied walking speeds, preservation of directional bearing, excessive re-routing of a provider, traffic, weather, etc.

Using the generated candidate stop locations from the stop location generator 204, the coalescing controller system 102 can then generate various driving route options and, in turn, generate corresponding scores for the driving route options via a route scoring engine 206. In particular, the route scoring engine 206 can generate route scores for up to each driving route option of one or more combinations of requestors 108a-108n. For example, the route scoring engine 206 can generate route scores based on a driving score and/or a walking score for each given driving route option. As an amount of driving involved with a given driving route option increases, the driving score also increases. Likewise, as an amount of walking involved with a given driving route option increases, the walking score also increases. In this manner, the route score for a driving route option reflects a cost and/or efficiency for both providers and requestors. For instance, less walking efficiency or larger amounts of walking (reflected in a higher walking score) can increase an overall route score or otherwise negatively counter increased provider efficiencies or decreased amounts of driving (reflected in a lower driving score), and vice-versa. Similarly, more walking efficiency or less amounts of walking (reflected in a lower walking score) can decrease an overall route score or otherwise positively counter decreased provider efficiencies or increased amounts of driving (reflected in a higher driving score), and vice-versa.

Based on the route scores generated by the route scoring engine 206, a threshold distance/ETA controller 208 can determine whether one or more of the driving route options can include at least one coalesced stop location. Specifically, if a pick-up/drop-off location of at least one requestor is within a threshold distance and/or threshold ETA from one or more different pick-up/drop-off locations of one or more walking-eligible requestors, the threshold distance/ETA controller 208 can determine that coalescing stop locations is available for a given driving route option. Conversely, if a pick-up/drop-off location of at least one requestor is not within a threshold distance and/or threshold ETA from one or more different pick-up/drop-off locations of one or more walking-eligible requestors, the threshold distance/ETA controller 208 can determine that coalescing stop locations is not available for a given driving route option. Accordingly, the threshold distance/ETA controller 208 can use a variety of processes to measure, estimate, predict, determine, infer, hold constant, or otherwise obtain distances and ETAs for comparison with a threshold ETA and/or a threshold distance.

For a pick-up/drop-off location of at least one requestor that is within a threshold distance and/or threshold ETA from one or more different pick-up/drop-off locations of one or more walking-eligible requestors, the threshold distance/ETA controller 208 can communicate with the route scoring engine 206 and/or the coalescing controller system 102 about the possible coalesced stop locations for one or more driving route options. In response, the route scoring engine 206 may update one or more route scores to reflect the possibility of coalescing one or more stop locations. In particular, the route scoring engine 206 can weight the driving route options based on the number of reduced stop locations possible. In more detail, the route scoring engine 206 can favorably lower one or more route scores by applying a coalescing factor to a route score.

Using the route scores for the various combinations of requestors 108a-108n, including route scores reflecting a coalescing factor, the coalescing controller system 102 can select one or more optimal or favorable driving route options for responding to the transportation requests 202. Based on the selection, the coalescing controller system 102 can then send instructions to the requestor device 210 and/or the provider device 212 in accordance with the selected driving route options.

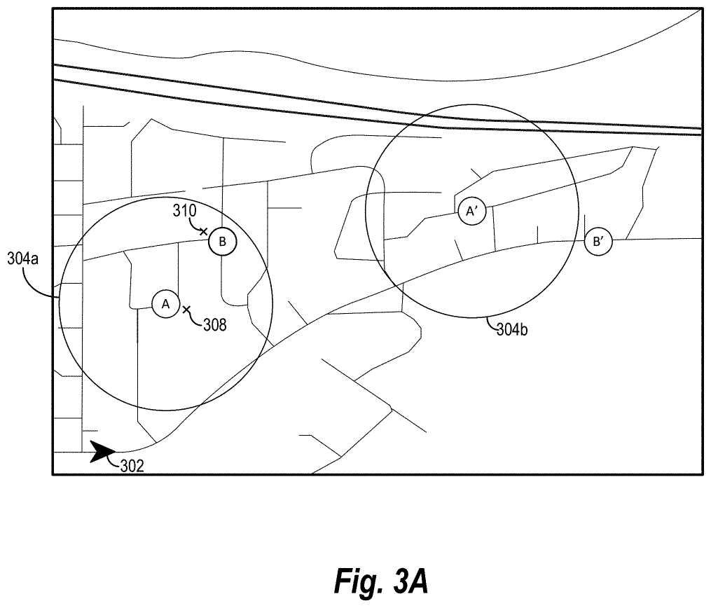

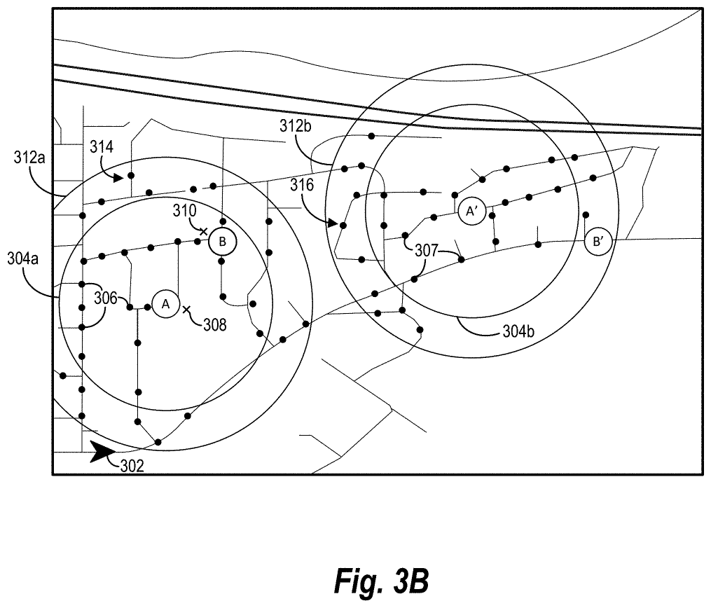

As mentioned above, the coalescing controller system 102 can selectively determine to coalesce stop locations. FIGS. 3A-3B illustrate a map diagram of example stop locations A, B, A′, and B′, in accordance with one or more embodiments of the present disclosure. As shown, FIG. 3A illustrates a provider 302 relative to two requestors 308, 310. In this example scenario, the requestor 308 is associated with a possible pick-up location at stop location A and a possible drop-off location at stop location A′ (albeit the requestor 308 is shown as currently positioned at stop location A). Further, the requestor 310 is associated with a possible pick-up location at stop location B and a possible drop-off location at stop location B′ (albeit the requestor 310 is shown as currently positioned at stop location B).

In addition, for this example scenario, the requestor 308 is eligible to walk, and the requestor 310 is not eligible to walk based on their respective transportation requests. Accordingly, FIG. 3A illustrates thresholds 304a and 304b representative of a threshold distance and/or a threshold ETA relative to respective stop locations A and A′ that are associated with the requestor 308. Using the thresholds 304a and 304b, the coalescing controller system 102 can relocate the stop locations A and A′ to a different position within the thresholds 304a and 304b. In addition, the coalescing controller system 102 may use the same or different size thresholds such that the threshold 304a can be the same as or different from the threshold 304b. For example, the thresholds 304a and 304b may be dynamic thresholds that are size-configurable in response to a number of factors (e.g., geolocation, traffic, time of day, a number of nearby requestors, a number of available transportation providers, etc.).

For example, FIG. 3B illustrates some example sets of candidate stop locations 306, 307, 314, and 316 in accordance with one or more embodiments. The sets of candidate stop locations 306, 307, 314, and 316 are indeed alternate stop locations to A and A′. Specifically, as shown the coalescing controller system 102 generates the sets of candidate stop locations 306, 307 respectively positioned within the thresholds 304a and 304b in addition to larger thresholds 312a and 312b. Further, the coalescing controller system 102 generates the sets of candidate stop locations 314, 316 respectively positioned within the larger thresholds 312a and 312b and outside the thresholds 304a and 304b. To generate the sets of candidate stop locations 314, 316, the coalescing controller system 102 can use a Haversine approach employing the Haversine formula. Additionally or alternatively, the coalescing controller system 102 can use fixed or variable distances from intersections (e.g., 20-30 meters) to generate candidate stop locations. Additionally or alternatively, the coalescing controller system 102 can employ bandit testing for simultaneous exploration and exploitation of candidate stop locations.

Based on at least some of the sets of candidate stop locations 306, 307, 314, and 316, the coalescing controller system 102 can generate driving route options for transporting the requestors 308, 310 according to various combinations of candidate stop locations in one or more of the sets of candidate stop locations 306, 307, 314, and 316. In turn, the coalescing controller system 102 can generate route scores for the driving route options. Additionally, the coalescing controller system 102 can determine whether one or more stop locations are eligible to coalesce. For example, the coalescing controller system 102 can determine that the stop locations A and B are both within the threshold 304a and are therefore eligible for coalescing. Similarly, for example, the coalescing controller system 102 can determine that the stop locations A′ and B′ are not both within the threshold 304b and are therefore not eligible for coalescing. However, in some embodiments, the coalescing controller system 102 can use the larger threshold 312b and determine that the stop locations A′ and B′ are both within the larger threshold and therefore are eligible for coalescing.

With the driving route options, the coalescing controller system 102 can then generate and compare route scores to select the optimal driving route option and provide corresponding instructions to a provider 302 and the requestors 308, 310. To do so, in some embodiments, the coalescing controller system 102 generates a route score that does not include a coalesced stop location (i.e., a non-coalesced driving route option). Specifically, one route score for this example embodiment can include a route score for an optimal driving route option with four separate stops at stop locations of, for example: (A, B, A′, and B′); (Aₐₗₜₑᵣₙₐₜₑ, B, A′ₐₗₜₑᵣₙₐₜₑ, and B′); (Aₐₗₜₑᵣₙₐₜₑ, B, A′, B′); or (A, B, A′ₐₗₜₑᵣₙₐₜₑ, B′), where Aₐₗₜₑᵣₙₐₜₑ represents a stop location in the sets of candidate stop locations 306, 314 and A′ₐₗₜₑᵣₙₐₜₑ represents a stop location in the sets of candidate stop locations 307, 316.

The coalescing controller system 102 can then compare the optimal non-coalesced driving route option with one or more coalesced driving route options. For example, the coalescing controller system 102 in this example embodiment can include a route score for a coalesced driving route option with one or more combined stops at stop locations of, for example: (B, B′); (B, A′, B′); (B, A′ₐₗₜₑᵣₙₐₜₑ, B′); (A, B, B′); and/or (Aₐₗₜₑᵣₙₐₜₑ, B, B′). In addition to driving scores and walking scores likewise generated for the non-coalesced driving route options, the coalescing controller system 102 also generates the route scores associated with the coalesced driving route options to include a coalescing factor. In this case, the coalescing controller system 102 will associate the driving route option having stop locations at only B and B′ with a coalescing factor that is double that of the other coalesced driving route options. Specifically, the coalescing factor is doubled because the driving route option with stop locations of only B and B′ reduces the number of stop locations by two, while the other coalesced driving route options reduce the number of stop locations by one. Then, depending on which route score is lowest (the optimal non-coalesced driving route option or a coalesced driving route option), the coalescing controller system 102 can select the optimal driving route option and send corresponding instructions to the provider 302 and the requestors 308, 310. Additionally or alternatively, stop locations B and B′ can each include a separate coalescing factor as each stop location can present separate coalescing opportunities.

As described above for the example embodiment of FIG. 3B, the thresholds 304a and 304b and the larger thresholds 312a and 312b are relative to stop locations A and A′, which in this case are a possible pick-up location and possible drop-off location, respectively, for the requestor 308. However, in other embodiments, the coalescing controller system 102 may use one or more thresholds relative to a request location where the requestor 308 is positioned at the time of initiating the transport request (e.g., not necessarily relative to a pick-up location). For example, were the requestor 308 not positioned at the possible stop location A (in contrast to that shown in FIG. 3B) at the time of submitting a transportation request, the coalescing controller system 102 can associate one or both of the threshold 304a and the larger threshold 312a with the request location instead of the stop location A. Similarly, in other embodiments, the coalescing controller system 102 can use one or more thresholds relative to a destination to which the requestor 308 requests transportation in the transportation request (e.g., not necessarily relative to a drop-off location). For example, given some destination located differently than the stop location A′ for the requestor 308, the coalescing controller system 102 can associate one or both of the threshold 304b and the larger threshold 312b with the destination instead of the stop location A′.

Additionally or alternatively, in some embodiments, the coalescing controller system 102 can use any suitable number, size, and/or combination of thresholds in generating candidate stop locations. For example, the coalescing controller system 102 can use the threshold 304a relative to stop location A and the larger threshold 312b relative to the stop location A′ in generating sets of candidate stop locations (e.g., the set of candidate stop locations 306 relative to A and the sets of candidate stop locations 307, 316 relative to A′). For instance, the coalescing controller system 102 may implement varying threshold sizes (e.g., varying threshold distances or varying threshold ETAs) based on a multitude of factors involving optimization of pick-up and drop-off of requestors. For example, and as mentioned above, the thresholds 304a, 304b, 312a, and 312b may be dynamic thresholds that are size-configurable in response to a number of factors (e.g., geolocation, traffic, time of day, a number of nearby requestors, a number of available transportation providers, etc.).

Further, in some embodiments, the coalescing controller system 102 can generate other suitable numbers and/or arrangements of candidate stop locations than that expressly shown in FIG. 3B. In addition, the candidate stop locations shown in FIG. 3B are schematic in nature, and not necessarily depicted to scale or with positional precision. For example, at least one candidate stop location in the sets of candidate stop locations 306, 307, 314, and/or 316 for the requestor 308 can include the actual position of the illustrated stop locations B and B′ associated with the requestor 310.

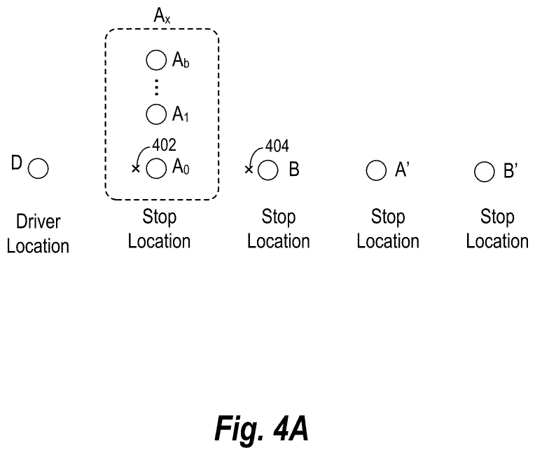

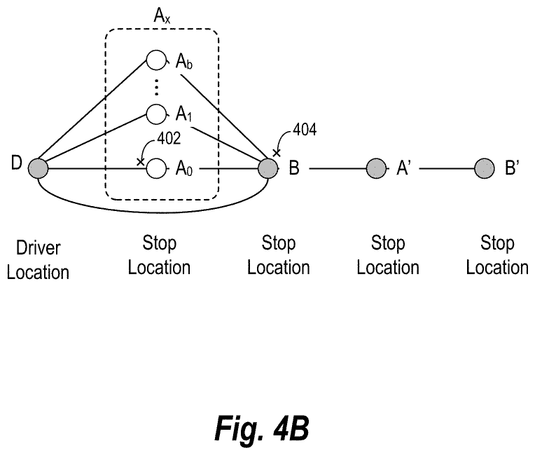

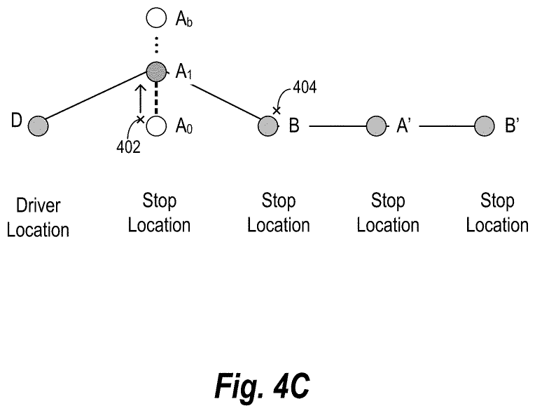

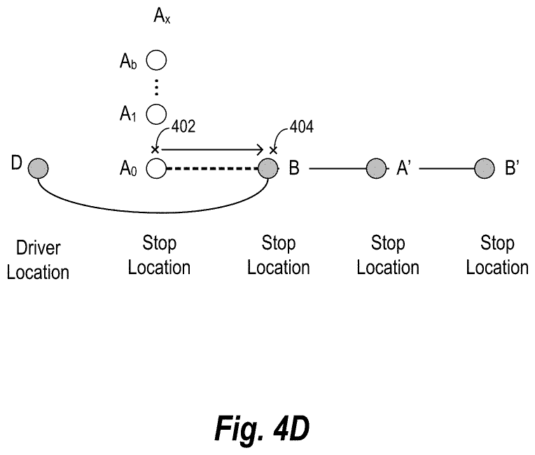

As described above, the coalescing controller system 102 can selectively determine to coalesce stop locations. FIGS. 4A-4D illustrate example schematic diagrams depicting the coalescing controller system 102 determine to coalesce stop locations for pick-up of two requestors 402 and 404, in accordance with one or more embodiments of the present disclosure. As shown in FIG. 4A, a driver is positioned at a driver location D; the requestor 402 is positioned for pick-up at a candidate stop location A₀ among a set of candidate stop locations Aₓ; the requestor 404 is positioned for pick-up at a stop location B; and stop locations A′ and B′ correspond, respectively, to drop-off locations for the requestors 402 and 404. In this example embodiment, the requestor 402 is eligible to walk based on an associated transportation request, while the requestor 404 is not eligible to walk based on an associated transportation request. Accordingly, the requestor 402 is associated with the set of candidate stop locations Aₓ and the requestor 404 is not associated with a set of candidate stop locations.

To select a driving route option for transporting the requestors 402, 404, the coalescing controller system 102 generates for analysis one or more driving route options as shown in FIG. 4B, arranged in accordance with one or more embodiments. In particular, the coalescing controller system 102 can consider driving route options of, for example: (D-A₀-B-A′-B′); (D-A₁-B-A′-B′); and so forth to (D-A_{b}-B-A′-B′). In these example driving route options, A₀ represents a candidate stop location associated with a position of the requestor 402 (e.g., a request location where the requestor 402 sends a transportation request to the dynamic transportation matching system 103). In addition, A₁ represents another candidate stop location positioned within a threshold distance and/or threshold ETA (e.g., relative to A₀). Further, A_{b} represents yet another candidate stop location within the threshold distance and/or threshold ETA (e.g., relative to A₀). In some embodiments, for example where the stop location B is within the threshold distance and/or threshold ETA from A₀, then A_{b} can be positioned at the stop location B such that A_{b} and B are the same locations. In this example case, the driving route option (D-A_{b}-B-A′-B′) can then be the same as or similar to a coalesced driving route option (D-B-A′-B′) available where the stop location B is within the threshold distance and/or threshold ETA from A₀.

With the generated driving route options discussed above, the coalescing controller system 102 can further generate route scores for one or more of the driving route options. In particular, the coalescing controller system 102 can generate a route score based on a walking score and a driving score, each discussed in turn.

The walking score reflects a cost associated with the requestor 402 walking from A₀ to be picked up. Accordingly, the driving route option (D-A₀-B-A′-B′) has a first walking score of zero since the requestor 402 does not walk from A₀. However, a second walking score (e.g., for the driving route option (D-A₁-B-A′-B′)) can reflect a first travel metric (e.g., a first walking time or first walking distance) from A₀ to A₁; a third walking score (e.g., for a driving route option (D-A₂-B-A′-B′)) can reflect a second travel metric (e.g., a second walking time or second walking distance) from A₀ to A₂; a fourth walking score (e.g., for a driving route option (D-A₃-B-A′-B′)) can reflect a third travel metric (e.g., a third walking time or third walking distance) from A₀ to A₃; and so forth to an n^{th} walking score (e.g., for a driving route option (D-A_{b}-B-A′-B′)) reflecting an nth travel metric (e.g., an nth walking time or nth walking distance) from A₀ to A_{b}. In addition, the coalescing controller system 102 can generate a walking score for the coalesced driving route option (D-B-A′-B′) if applicable (e.g., stop location B is within a threshold distance and/or threshold ETA from A₀). Accordingly, the walking score for the coalesced driving route option reflects a travel metric (e.g., a walking time or walking distance) from A₀ to B, where the requestors 402 and 404 can be picked up together at the stop location B. Additionally or alternatively, the walking score can reflect a degree of difficulty/complexity of walking a portion of a driving route option. For example, the coalescing controller system 102 may penalize non-linear walking paths more than linear walking paths, etc.

Similarly, the driving score reflects a cost associated with a provider driving from the driver location D to transport the requestors 402, 404. Thus, a first driving score (e.g., for the driving route option (D-A₀-B-A′-B′)) can reflect a drive from D to A₀ to B to A′ to B′; a second driving score (e.g., for the driving route option (D-A₁-B-A′-B′)) can reflect a drive from D to A₁ to B to A′ to B′; a third driving score (e.g., for the driving route option (D-A₂-B-A′-B′)) can reflect a drive from D to A₂ to B to A′ to B′; a fourth driving score (e.g., for the driving route option (D-A₃-B-A′-B′)) can reflect a drive from D to A₃ to B to A′ to B′; and so forth to an nth driving score (e.g., for the driving route option (D-A_{b}-B-A′-B′)) reflecting a drive from D to A_{b} to B to A′ to B′. In addition, the coalescing controller system 102 can generate a driving score for the coalesced driving route option (D-B-A′-B′) if applicable (e.g., stop location B is within a threshold distance and/or threshold ETA from A₀). Accordingly, the driving score for the coalesced driving route option reflects a drive from D to B to A′ to B′.

In addition to the driving score and the walking score, for the coalesced driving route option (D-B-A′-B′), the coalescing controller system 102 can further generate an overall route score by apply a coalescing factor. The coalescing factor favorably weights the coalesced driving route option by reducing the route score for the coalesced driving route option. In particular, the coalesced driving route option reduces one stop location, and therefore the route score for the coalesced driving route option includes a coalescing factor of (1·x).

In more detail, the coalescing controller system 102 can generate a route score for each of the driving route options, including the coalesced driving route option, according to the following example pseudo-expression:

Route Score=Driving Score+Walking Score−Coalescing Factor

In addition, one or more components of the above route score expression can be reflected in the following example pseudo-expression:

$$Route Score = ( M 1 * Driving Time Score ) + ( M 2 * Driving Distance Score ) + ( M 3 * Walking Time Score ) + ( M 4 * Walking Distance Score ) - Coalescing Factor ,$$

where M1, M2, M3, and M4 are coefficients. Using the above expression(s), the coalescing controller system 102 can determine one or more versions of a route score. For example, the coalescing controller system 102 can employ a distance-based route score that considers costs associated with distance (but not time) such that:

M1=M3=0; and M2=M4=1.

Additionally or alternatively, the coalescing controller system 102 can employ a combined distance-time route score that considers costs associated with both distance and time such that:

M1=M2=M3=M4=1.

Additionally or alternatively, the coalescing controller system 102 can employ a time-based route score that considers costs associated with time (but not distance) such that:

M1=M3=1; and M2=M4=0.

Additionally or alternatively, the coalescing controller system 102 can employ a weighted distance-time route score that considers costs in a variable fashion by applicably weighting distance and/or time for one or both of walking and driving cost terms such that:

M1=α; M2=β; M3=γ; and M4=μ,

where α, β, γ, and μ can be the same or different values in the closed range [0,1].

In these or other embodiments, the coalescing controller system 102 can measure, estimate, predict, determine, infer, consider as a constant value, or otherwise obtain distances and/or the ETAs for generating the route scores described above. For example, the coalescing controller system 102 can use Google® Maps data to obtain distances and/or the ETAs for both driving and walking portions of a driving route option. Additionally or alternatively, to reduce computational overhead of executing one or more expensive API calls (e.g., for walking ETAs) or otherwise increase processing speed for real-time assessments and route score generation, the coalescing controller system 102 can infer, extrapolate, etc. to obtain various information. For instance, instead of separately obtaining a walking ETA between locations of a driving route option, the coalescing controller system 102 can substitute a driving ETA for the walking ETA. Specifically, the coalescing controller system 102 can use a driving ETA for the walking portion of the driving route option and apply a conversion factor to that driving ETA in order to generate the walking ETA of the walking portion. Other processes to obtain distances and/or the ETAs for generating route scores described above for the walking portions and driving portions of a given driving route option are herein contemplated.

With the route scores generated, the coalescing controller system 102 can then select an optimal non-coalesced driving route option (as shown for example in FIG. 4C) for comparison with one or more coalesced driving route options to determine an actual route for transporting the requestors 402, 404. As illustrated in the schematic diagram of FIG. 4C, the coalescing controller system 102 has selected the driving route option (D-A₁-B-A′-B′) as the optimal non-coalesced driving route option. For instance, the coalescing controller system 102 can select the driving route option (D-A₁-B-A′-B′) as the optimal non-coalesced driving route option based on a lowest route score compared to the other route scores associated with the other non-coalesced driving route options. Specifically, FIG. 4C shows that for the driving route option (D-A₁-B-A′-B′), a provider would drive from the driver location D to A₁ to B to A′ to B′. Further shown, the requestor 402 would walk from A₀ to A₁ for pick-up, and the requestor 404 would remain at the stop location B for pick-up.

In contrast to FIG. 4C, FIG. 4D illustrates a schematic diagram in which the coalescing controller system 102 has selected the coalesced driving route option (D-B-A′-B′). Specifically, FIG. 4D shows that for the coalesced driving route option (D-B-A′-B′), a provider would drive from the driver location D to B to A′ to B′. Further shown, the requestor 402 would walk from A₀ to B for pick-up, and the requestor 404 would remain at the stop location B for pick-up.

Based on the route scores for the driving route options shown in FIGS. 4C and 4D, the coalescing controller system 102 can determine to coalesce stop locations A0 and B and then select the coalesced driving route option since the coalesced route score for the coalesced driving route option (D-B-A′-B′) is less than the non-coalesced route score for the non-coalesced driving route option (D-A1-B-A′-B′). Otherwise, if the non-coalesced route score for the non-coalesced driving route option (D-A1-B-A′-B′) were less than the coalesced route score for the coalesced driving route option (D-B-A′-B′), then the coalescing controller system 102 would select the non-coalesced driving route option.

→ select the noncoalesced driving route option.

In turn, the coalescing controller system 102 can then send transportation instructions in accordance with the selected driving route option to the provider and the requestors 402, 404.

In these or other embodiments, more or fewer stop locations and/or candidate stop locations can be included than what is expressly shown in FIGS. 4A-4D. In particular, candidate stop locations for the stop location A′ are not shown (in this case for simplicity and brevity). However, in other embodiments, the stop location A′ can be associated with a set of candidate stop locations (e.g., for drop-off of the requestor 202), and the processes described above can be applied as done with the set of candidate stop locations A.

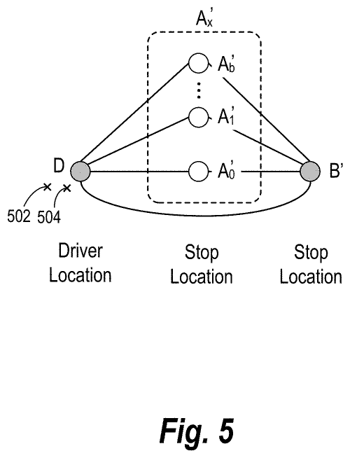

As mentioned above, the coalescing controller system 102 can selectively determine to coalesce stop locations, including drop-off locations. FIG. 5 illustrates an example schematic diagram depicting the coalescing controller system 102 determine to coalesce stop locations for drop-off of two requestors 502 and 504, in accordance with one or more embodiments of the present disclosure. As shown in FIG. 5, a driver is positioned at a driver location D; and the requestors 502, 504 are likewise positioned at the driver location D representing that the requestors 502, 504 are in transport with the provider. Further, stop locations A′ and B′ correspond, respectively, to drop-off locations for the requestors 502, 504. In this example embodiment, the requestor 502 is eligible to walk based on an associated transportation request, while the requestor 504 is not eligible to walk based on an associated transportation request. Accordingly, the requestor 502 is associated with the set of candidate stop locations A′ₓ and the requestor 504 is not associated with a set of candidate stop locations. In the same or similar manner as described above (e.g., in conjunction with FIGS. 2-4D), the coalescing controller system 102 can generate driving route options and corresponding route scores, and determine to coalesce stop locations based on the route scores. For example, the coalescing controller system 102 may determine to coalesce stop locations at the stop location B′ and provide instructions to the provider and the requestors 502, 504 regarding the drop-off of both requestors 502, 504 at the stop location B′.

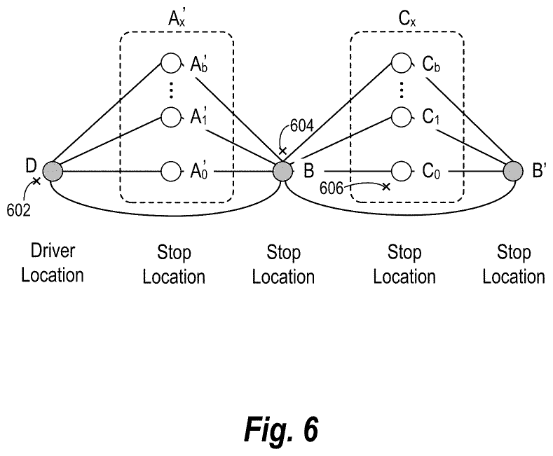

As also mentioned above, the coalescing controller system 102 can selectively determine to coalesce stop locations, whether drop-off locations and/or pick-up locations. FIG. 6 illustrates an example schematic diagram depicting the coalescing controller system 102 determine to coalesce stop locations for requestors 602, 604, and 606 in accordance with one or more embodiments of the present disclosure. As shown in FIG. 6, a driver is positioned at a driver location D; the requestor 602 is likewise positioned at the driver location D representing that the requestor 602 is in transport with the provider; the requestor 604 is positioned for pick-up at the stop location B; and the requestor 606 is positioned for pick-up at a candidate stop location C₀ among a set of candidate stop locations Cₓ. Further, a set of candidate stop locations A′ₓ corresponds to the requestor 602, and the stop location B′ corresponds to the requestor 604. In this example embodiment, the requestors 602, 606 are eligible to walk based on associated transportation requests, while the requestor 604 is not eligible to walk based on an associated transportation request. Accordingly, the requestors 602, 606 are associated with the set of candidate stop locations A′ₓ and Cₓ, respectively, and the requestor 604 is not associated with a set of candidate stop locations.

Further, in the same or similar manner as described above (e.g., in conjunction with FIGS. 2-4D), the coalescing controller system 102 can generate driving route options and corresponding route scores, and determine to coalesce stop locations based on the route scores. For example, the coalescing controller system 102 may determine to coalesce stop locations at the stop location B and provide corresponding instructions to the provider and the requestors 602, 604, and 606 regarding the drop-off of the requestor 602 and pick-up of requestors 604, 606, all at the stop location B. Alternatively, for example, the coalescing controller system 102 may determine to coalesce stop locations at the stop locations B and B′ and provide corresponding instructions to the provider and the requestors 602, 604, and 606. In particular, the coalescing controller system 102 may provide instructions for the drop-off of the requestor 602 and the pick-up of the requestor 604, both at the stop location B. In addition, the coalescing controller system 102 may provide instructions for the drop-off of the requestor 604 and the pick-up of the requestor 606, both at the stop location B′.

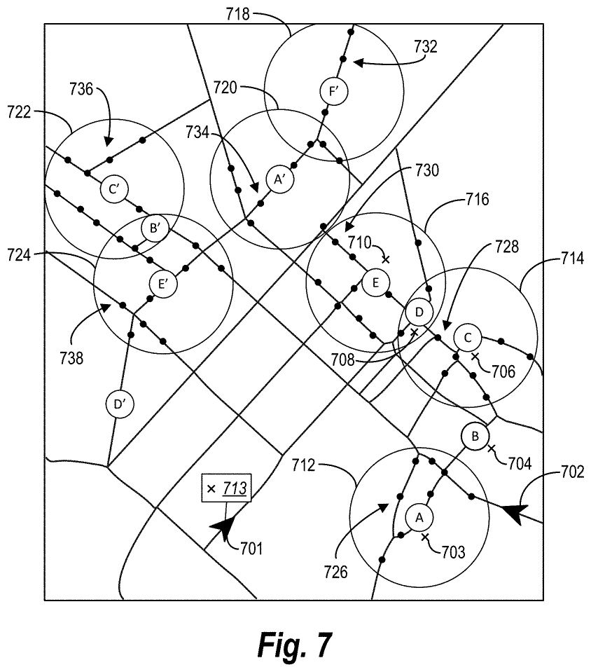

As mentioned above, the coalescing controller system 102 can selectively determine to coalesce stop locations, whether drop-off locations and/or pick-up locations. FIG. 7 illustrates a map diagram for determining to coalesce stop locations for one or more requestors 703-713, in accordance with one or more embodiments of the present disclosure. As shown in FIG. 7, the map diagram includes a provider 701 and a provider 702; the requestor 703 is positioned for pick-up at stop location A; the requestor 704 is positioned for pick-up at stop location B; the requestor 706 is positioned for pick-up at stop location C; the requestor 708 is positioned for pick-up at stop location D; the requestor 710 is positioned for pick-up at stop location E; and the requestor 713 is associated with the provider 701 representing that the requestor 713 is in transport with the provider 701.

In this example embodiment, the requestors 703, 706, 710, and 713 are eligible to walk based on associated transportation requests, while the requestors 704 and 708 are not eligible to walk based on associated transportation requests. Accordingly, the requestor 703 is associated with sets of candidate stop locations 726 and 734 that are proximate to stop locations A and A′, respectively. Further shown, the requestor 706 is associated with sets of candidate stop locations 728 and 736 that are proximate to stop locations C and C′, respectively. Similarly, the requestor 710 is associated with sets of candidate stop locations 730 and 738 that are proximate to stop locations E and E′, respectively. In addition, the requestor 713 is associated with a set of candidate stop locations 732 that is proximate to stop location F′. The other requestors 704 and 708 are not associated with a set of candidate stop locations given the requestors 704, 708 are not eligible to walk.

Further, in the same or similar manner as described above (e.g., in conjunction with FIGS. 2-4D), the coalescing controller system 102 can generate driving route options and corresponding route scores, and determine to coalesce stop locations based on the route scores. For example, the coalescing controller system 102 may determine to coalesce stop locations E, D, and C at the stop location D based on overlapping thresholds 714, 716. In turn, the coalescing controller system 102 can provide corresponding instructions to the provider 702 and the requestors 706, 708, and 710 regarding pick-up of the requestors 706, 708, and 710, all at the stop location D. Additionally, for example, the coalescing controller system 102 may determine to coalesce stop locations C′, B′, and E′ at the stop location B′ based on overlapping thresholds 722, 724. In turn, the coalescing controller system 102 can provide corresponding instructions to the provider 702 and the requestors 704, 706, and 710 regarding drop-off of the requestors 704, 706, and 710, all at the stop location B′. To perform this driving route option, the coalescing controller system 102 may instruct the provider 702 to pick up the requestor 704 at stop location B prior to picking up the requestors 706, 708, and 710, all at the stop location D.

Similarly, for example, the coalescing controller system 102 may determine to coalesce stop locations A′ and F′ at some candidate stop location mutually available within the overlapping thresholds 718, 720. In turn, the coalescing controller system 102 can provide corresponding instructions to the provider 701 and the requestors 703, 713 regarding drop-off of the requestors 703 and 713, all at an intermediate candidate stop location. To perform this driving route option, the coalescing controller system 102 may first instruct the provider 701 to pick up the requestor 703 at stop location A or some other candidate stop location within the set of candidate stop locations 726 of a threshold 712. Albeit the provider 701 adjusts a directional bearing to pick up the requestor 703, the coalescing controller system 102 can offset costs/inefficiencies of the provider 701 and/or requestor 713 by determining a direct driving route option proceeding from the pick-up location of the requestor 703 to the coalesced drop-off location for the requestors 703 and 713 without intermediate pick-ups or drop-offs.

In this manner, the coalescing controller system 102 in this example embodiment can reduce the number of stops at stop locations from eleven separate stops to six stops that can include coalesced stop locations. Numerous other suitable combinations of requestors and driving route options are herein contemplated and considered by the coalescing controller system 102 given the above description for FIG. 7 is provided merely as an example.

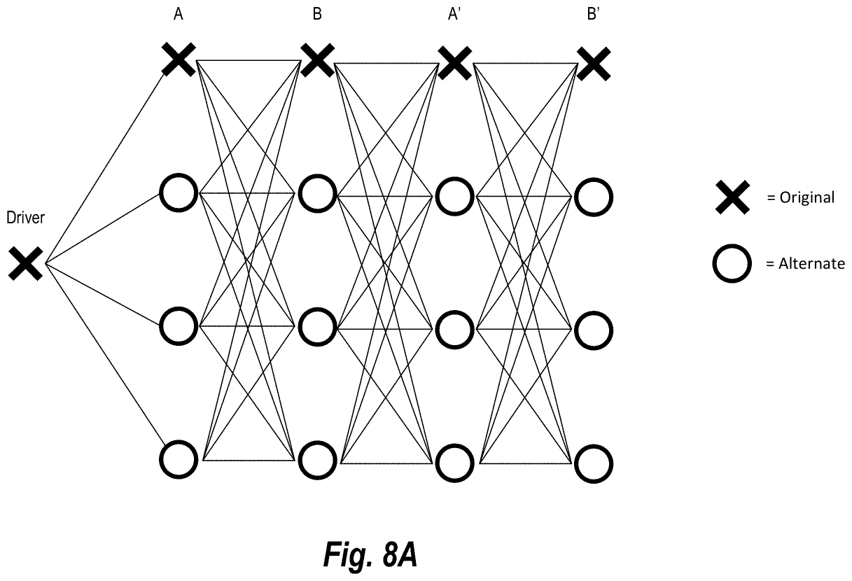

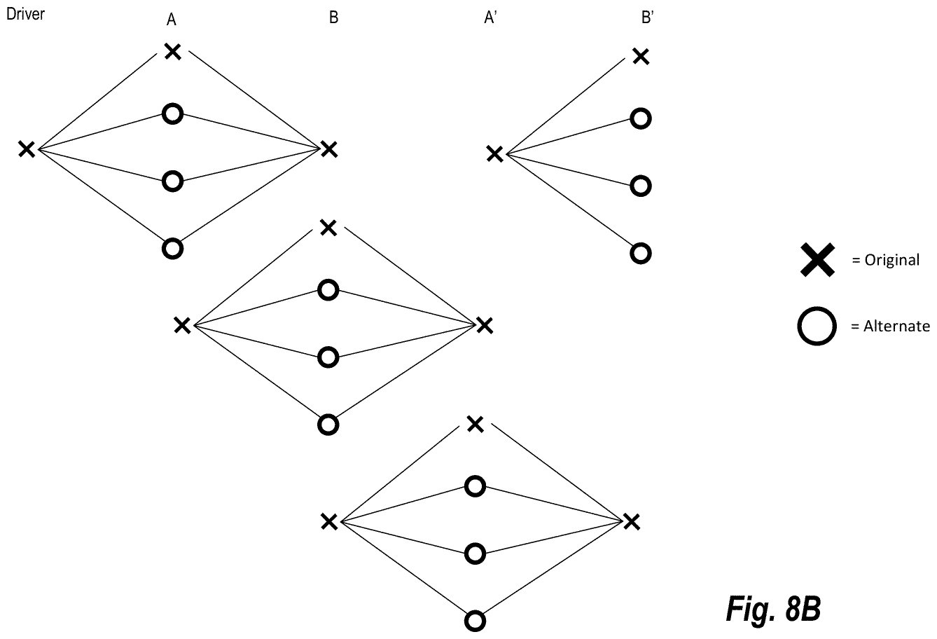

As mentioned above, the coalescing controller system 102 can generate driving route options based on candidate stop locations and determine one or more optimal driving route options. FIGS. 8A-8B illustrate some example schematic diagrams of optimization techniques for determining driving route options and/or scoring driving route options, in accordance with one or more embodiments. As shown, FIG. 8A depicts an example schematic diagram of a unified shortest-path optimization problem for four sets of candidate stop locations each having an original location (e.g., an original pick-up location or drop-off location) and three alternate locations (e.g., alternate pick-up locations or alternate drop-off locations). In these or other embodiments, an optimal driving route option can include a shortest path through all candidate stop locations such that exactly one edge is chosen between each candidate stop location. The coalescing controller system 102 can solve the unified shortest-path optimization problem shown in FIG. 8A using dynamic programming (e.g., Dijkstra's algorithm or another suitable process for solving the shortest path in a directed acyclic graph (DAG)).

In addition, FIG. 8B depicts an example schematic diagram of an independent ‘one-pass’ optimization problem for four sets of candidate stop locations each having an original location (e.g., an original pick-up location or drop-off location) and three alternate locations (e.g., alternate pick-up locations or alternate drop-off locations). The coalescing controller system 102 can solve the independent ‘one-pass’ optimization problem by assessing the path from the previous stop location, to a candidate stop location, to a next stop location. In particular, the coalescing controller system 102 can sort to find a lowest cost alternate or original location. Further, the coalescing controller system 102 can solve this optimization problem in parallel for each stop location and candidate stop location that is considered as walking-eligible.

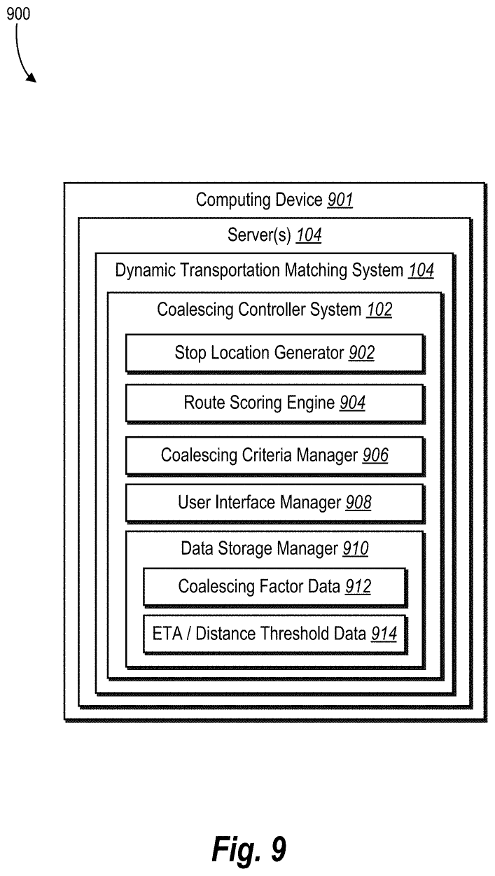

Turning now to FIG. 9, additional detail is provided regarding a computing system 900, including components and capabilities of the coalescing controller system 102 in accordance with one or more embodiments. As shown, the coalescing controller system 102 is implemented by a computing device 901, including the dynamic transportation matching system 103 of the server(s) 104. In some embodiments, the components of the coalescing controller system 102 can be implemented by a single device (e.g., the server(s) 104, the requestor devices 106a-106n, and/or the provider devices 110a-110n of FIG. 1) or multiple devices. As shown, the coalescing controller system 102 includes a stop location generator 902, a route scoring engine 904, a coalescing criteria manager 906, a user interface manager 908, and a data storage manager 910. Each is discussed in turn below.

As just mentioned, the coalescing controller system 102 includes the stop location generator 902. The stop location generator 902 may be the same as or similar to the stop location generator 204 of FIG. 2 and can identify, generate, receive, detect, filter, and/or determine stop locations, including candidate stop locations corresponding to pick-up and/or drop-off of requestors. For example, as discussed above, the stop location generator 902 can generate a set of candidate stop locations for a requestor based on an associated transportation request indicating the requestor is eligible for walking (e.g., is a shared saver rider).

The coalescing controller system 102 also includes the route scoring engine 904. The route scoring engine 904 may be the same as or similar to the route scoring engine 206 of FIG. 2 and can handle the generation and analyses of route scores based on a driving score and/or a walking score for each given driving route option. For example, as discussed above, the route scoring engine 904 can apply a coalescing factor to one or both of a walking score and a driving score to determine a route score.

Further shown in FIG. 9, the coalescing controller system 102 includes the coalescing criteria manager 906. The coalescing criteria manager 906 can perform acts to receive, identify, compare, analyze, determine, filter, pool, measure, etc. in order to determine whether the coalescing controller system 102 is eligible to and/or should coalesce a stop location. For example, as discussed above, the coalescing criteria manager 906 can pool transportation requests received within a given batching window and further determine that one or more stop locations are within a threshold distance and/or threshold ETA of each other.

As shown in FIG. 9, the coalescing controller system 102 can also include the user interface manager 908. The user interface manager 908 can provide, manage, and/or control a graphical user interface (or simply “user interface”). In particular, the user interface manager 908 may generate and display a user interface by way of a display screen composed of a plurality of graphical components, objects, and/or elements that allow a user to perform a function. For example, the user interface manager 908 can receive user inputs from a user, such as a click/tap to submit a transportation request. Additionally, the user interface manager 908 can present a variety of types of information, including text, digital media items, navigation directions, transportation matching digital content, etc.

The data storage manager 910 maintains data for the coalescing controller system 102. The data storage manager 910 can maintain data of any type, size, or kind, as necessary to perform the functions of coalescing controller system 102, including coalescing factor data 912 and ETA/distance threshold data 914 described above (in addition to other data, such as stop locations, candidate stop locations, driving route options, etc.).

Each of the components of the computing device 901 can include software, hardware, or both. For example, the components of the computing device 901 can include one or more instructions stored on a computer-readable storage medium and executable by processors of one or more computing devices, such as a client device or server device. When executed by the one or more processors, the computer-executable instructions of the coalescing controller system 102 can cause the computing device(s) (e.g., the computing device 901) to perform the methods described herein. Alternatively, the components of the computing device 901 can include hardware, such as a special-purpose processing device to perform a certain function or group of functions. Alternatively, the components of the computing device 901 can include a combination of computer-executable instructions and hardware.

Furthermore, the components of the computing device 901 may, for example, be implemented as one or more operating systems, as one or more stand-alone applications, as one or more modules of an application, as one or more plug-ins, as one or more library functions or functions that may be called by other applications, and/or as a cloud-computing model. Thus, the components of the computing device 901 may be implemented as a stand-alone application, such as a desktop or mobile application. Furthermore, the components of the computing device 901 may be implemented as one or more web-based applications hosted on a remote server.

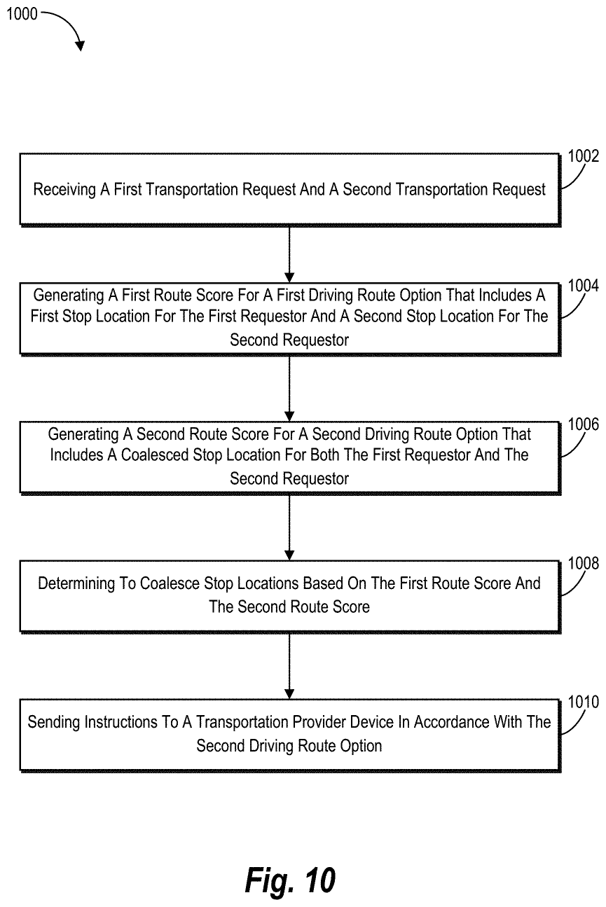

FIGS. 1-9, the corresponding text, and the examples provide several different systems, methods, techniques, components, and/or devices of the coalescing controller system 102 in accordance with one or more embodiments. In addition to the above description, one or more embodiments can also be described in terms of flowcharts including acts for accomplishing a particular result. For example, FIG. 10 illustrates a flowchart of a series of acts 1000 for selectively coalescing stop locations in the dynamic transportation matching system 103 in accordance with one or more embodiments. The coalescing controller system 102 may perform one or more acts of the series of acts 1000 in addition to or alternatively to one or more acts described in conjunction with other figures. While FIG. 10 illustrates acts according to one embodiment, alternative embodiments may omit, add to, reorder, and/or modify any of the acts shown in FIG. 10. The acts of FIG. 10 can be performed as part of a method. Alternatively, a non-transitory computer-readable medium can comprise instructions that, when executed by one or more processors, cause a computing device to perform the acts of FIG. 10. In some embodiments, a system can perform the acts of FIG. 10.

As shown, the series of acts 1000 includes an act 1002 of receiving a first transportation request from a first requestor device associated with a first requestor and a second transportation request from a second requestor device associated with a second requestor.

The series of acts 1000 further includes an act 1004 of generating a first route score for a first driving route option that includes a first stop location for the first requestor and a second stop location for the second requestor. In some embodiments, act 1004 includes generating, for the transportation provider, a driving score based on a stop for the first requestor at the first stop location and a stop for the second requestor at the second stop location. Additionally or alternatively, act 1004 can include generating, for the first requestor, a walking score based on a first travel metric from a request location to the first stop location or based on a second travel metric from the first stop location to a destination.

Further, an act in the series of acts 1000 includes an act 1006 of generating a second route score for a second driving route option that includes a coalesced stop location for both the first requestor and the second requestor. In some embodiments, act 1006 includes generating, for the transportation provider, a driving score based on a coalesced stop for both the first requestor and the second requestor at the coalesced stop location. Additionally or alternatively, the act 1006 can include generating, for the first requestor, a walking score based on a third travel metric from a request location to the coalesced stop location or based on a fourth travel metric from the coalesced stop location to a destination. In these or other embodiments, the request location is a geographic area where the first requestor initiates the first transportation request, and the destination is a geographic area to which the first requestor requests transportation in the first transportation request. In some embodiments, act 1006 includes applying a coalescing factor that weights the second driving route option based on a number of reduced stop locations compared to the first driving route option.

In addition, an act in the series of acts 1000 includes an act 1008 of determining to coalesce stop locations based on the first route score and the second route score. In these or other embodiments, a coalesced stop location includes at least one of: a pick-up location for both the first requestor and the second requestor; a pickup location for the first requestor and a drop-off location for the second requestor; a drop-off location for the first requestor and a pick-up location for the second requestor; or a drop-off location for both the first requestor and the second requestor.

Further, an act in the series of acts 1000 includes an act 1010 of sending instructions to a transportation provider device associated with a transportation provider in accordance with the second driving route option. Additionally or alternatively, the act 1010 can include sending instructions to one or more requestor devices associated with one or more corresponding requestors in accordance with the second driving route option.

It is understood that the outlined acts in the series of acts 1000 are only provided as examples, and some of the acts may be optional, combined into fewer acts, or expanded into additional acts without detracting from the essence of the disclosed embodiments. As an example of one or more additional or alternative acts not shown in FIG. 10, act(s) in the series of acts 1000 may include determining that the first stop location and the second stop location are within a threshold distance or a threshold estimated time to arrival; and in response to the determining, generating the first route score and the second route score to determine whether to coalesce the first stop location and the second stop location.

As another example of one or more additional or alternative acts not shown in FIG. 10, act(s) in the series of acts 1000 may include generating, for the first requestor, a set of candidate stop locations relative to a request location of the first transportation request or relative to a destination of the first transportation request, wherein the first stop location is a candidate stop location in the set of candidate stop locations. Additionally or alternatively, act(s) in the series of acts 1000 may include generating a route score for each candidate stop location in the set of candidate stop locations, and wherein determining to coalesce stop locations based on the first route score and the second route score is further based on the route scores for each candidate stop location in the set of candidate stop locations.

As a further example of one or more additional or alternative acts not shown in FIG. 10, act(s) in the series of acts 1000 may include: receiving a set of transportation requests within a batching window; determining that stop locations for a subset of transportation requests of the set of transportation requests within the batching window are eligible for coalescing based on a threshold distance or a threshold estimated time to arrival between the transportation requests of the subset of transportation requests; and generating route scores for combinations of each transportation request of the subset of transportation requests, wherein determining to coalesce stop locations based on the first route score and the second route score is further based on the generated route scores for the combinations of each transportation request of the subset of transportation requests.

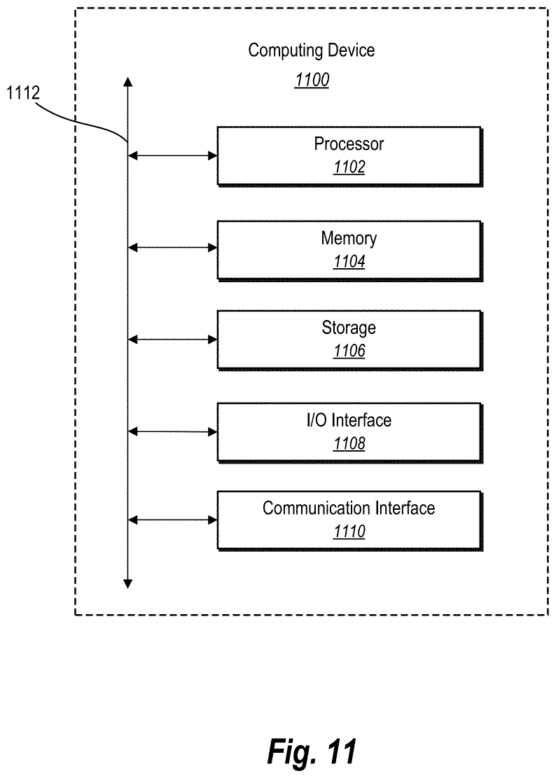

FIG. 11 illustrates a block diagram of an example computing device 1100 that may be configured to perform one or more of the processes described above. One will appreciate that one or more computing devices, such as the computing device 1100 may represent the computing devices described above (e.g., the computing system 900, the server(s) 104, etc.). In one or more embodiments, the computing device 1100 may be a mobile device (e.g., a mobile telephone, a smartphone, a PDA, a tablet, a laptop, a camera, a tracker, a watch, a wearable device, etc.). In some embodiments, the computing device 1100 may be a non-mobile device (e.g., a desktop computer or another type of client device). Further, the computing device 1100 may be a server device that includes cloud-based processing and storage capabilities.

As shown in FIG. 11, the computing device 1100 can include one or more processor(s) 1102, memory 1104, a storage device 1106, input/output interfaces 1108 (or “I/O interfaces 1108”), and a communication interface 1110, which may be communicatively coupled by way of a communication infrastructure (e.g., bus 1112). While the computing device 1100 is shown in FIG. 11, the components illustrated in FIG. 11 are not intended to be limiting. Additional or alternative components may be used in other embodiments. Furthermore, in certain embodiments, the computing device 1100 includes fewer components than those shown in FIG. 11. Components of the computing device 1100 shown in FIG. 11 will now be described in additional detail.

In particular embodiments, the processor(s) 1102 includes hardware for executing instructions, such as those making up a computer program. As an example, and not by way of limitation, to execute instructions, the processor(s) 1102 may retrieve (or fetch) the instructions from an internal register, an internal cache, memory 1104, or a storage device 1106 and decode and execute them.

The computing device 1100 includes memory 1104, which is coupled to the processor(s) 1102. The memory 1104 may be used for storing data, metadata, and programs for execution by the processor(s). The memory 1104 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1104 may be internal or distributed memory.

The computing device 1100 includes a storage device 1106 includes storage for storing data or instructions. As an example, and not by way of limitation, the storage device 1106 can include a non-transitory storage medium described above. The storage device 1106 may include a hard disk drive (HDD), flash memory, a Universal Serial Bus (USB) drive or a combination these or other storage devices.

As shown, the computing device 1100 includes one or more I/O interfaces 1108, which are provided to allow a user to provide input to (such as user strokes), receive output from, and otherwise transfer data to and from the computing device 1100. These I/O interfaces 1108 may include a mouse, keypad or a keyboard, a touch screen, camera, optical scanner, network interface, modem, other known I/O devices or a combination of such I/O interfaces 1108. The touch screen may be activated with a stylus or a finger.

The I/O interfaces 1108 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1108 are configured to provide graphical data to a display for presentation to a user. The graphical data may be representative of one or more graphical user interfaces and/or any other graphical content as may serve a particular implementation.

The computing device 1100 can further include a communication interface 1110. The communication interface 1110 can include hardware, software, or both. The communication interface 1110 provides one or more interfaces for communication (such as, for example, packet-based communication) between the computing device and one or more other computing devices or one or more networks. As an example, and not by way of limitation, communication interface 1110 may include a network interface controller (NIC) or network adapter for communicating with an Ethernet or other wire-based network or a wireless NIC (WNIC) or wireless adapter for communicating with a wireless network, such as a WI-FI. The computing device 1100 can further include a bus 1112. The bus 1112 can include hardware, software, or both that connects components of the computing device 1100 to each other.

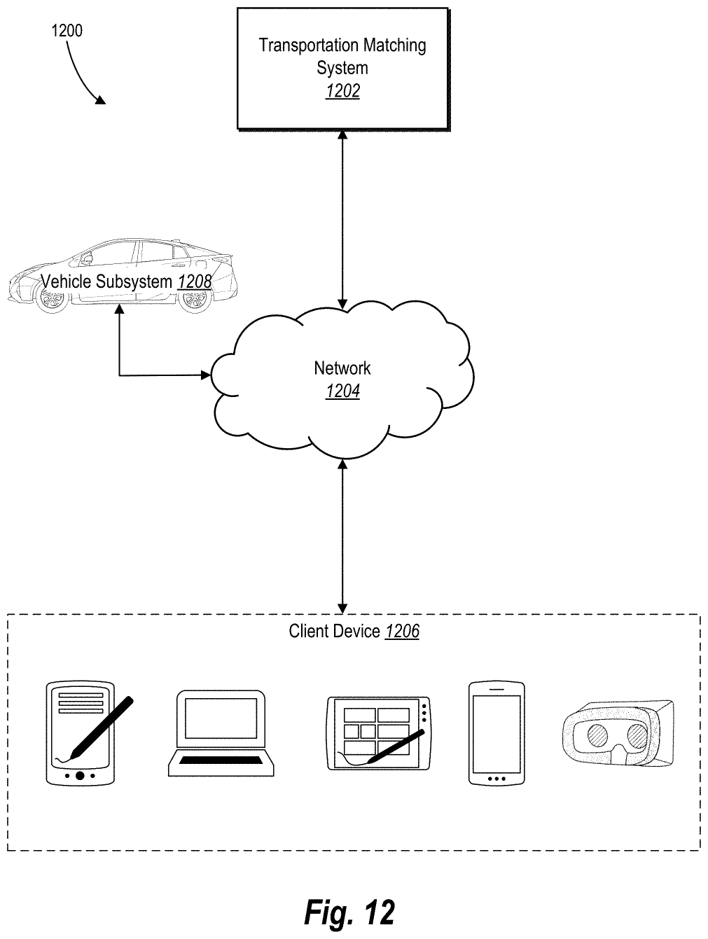

FIG. 12 illustrates an example network environment 1200 of a transportation matching system (e.g., the dynamic transportation matching system 103). The network environment 1200 includes a client device 1206, a transportation matching system 1202, and a vehicle subsystem 1208 connected to each other by a network 1204. Although FIG. 12 illustrates a particular arrangement of the client device 1206, the transportation matching system 1202, the vehicle subsystem 1208, and the network 1204, this disclosure contemplates any suitable arrangement of the client device 1206, the transportation matching system 1202, the vehicle subsystem 1208, and the network 1204. As an example, and not by way of limitation, two or more of the client device 1206, the transportation matching system 1202, and the vehicle subsystem 1208 communicate directly, bypassing the network 1204. As another example, two or more of the client device 1206, the transportation matching system 1202, and the vehicle subsystem 1208 may be physically or logically co-located with each other in whole or in part. Moreover, although FIG. 12 illustrates a particular number of the client devices 1206, the transportation matching systems 1202, the vehicle subsystems 1208, and the networks 1204, this disclosure contemplates any suitable number of the client devices 1206, the transportation matching systems 1202, the vehicle subsystems 1208, and the networks 1204. As an example, and not by way of limitation, the network environment 1200 may include multiple client devices 1206, the transportation matching systems 1202, the vehicle subsystems 1208, and the networks 1204.

This disclosure contemplates any suitable network 1204. As an example, and not by way of limitation, one or more portions of the network 1204 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. The network 1204 may include one or more networks 1204.

Links may connect the client device 1206, the transportation matching system 1202, and the vehicle subsystem 1208 to the communication network 1204 or to each other. This disclosure contemplates any suitable links. In particular embodiments, one or more links include one or more wireline (such as for example Digital Subscriber Line (DSL) or Data Over Cable Service Interface Specification (DOCSIS), wireless (such as for example Wi-Fi or Worldwide Interoperability for Microwave Access (WiMAX), or optical (such as for example Synchronous Optical Network (SONET) or Synchronous Digital Hierarchy (SDH) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout the network environment 1200. One or more first links may differ in one or more respects from one or more second links.

In particular embodiments, the client device 1206 may be an electronic device including hardware, software, or embedded logic components or a combination of two or more such components and capable of carrying out the appropriate functionalities implemented or supported by the client device 1206. As an example, and not by way of limitation, a client device 1206 may include any of the computing devices discussed above in relation to FIG. 12. A client device 1206 may enable a network user at the client device 1206 to access a network. A client device 1206 may enable its user to communicate with other users at other client devices 1206.

In particular embodiments, the client device 1206 may include a transportation service application or a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at the client device 1206 may enter a Uniform Resource Locator (URL) or other address directing the web browser to a particular server (such as server), and the web browser may generate a Hyper Text Transfer Protocol (HTTP) request and communicate the HTTP request to server. The server may accept the HTTP request and communicate to client device 1206 one or more Hyper Text Markup Language (HTML) files responsive to the HTTP request. The client device 1206 may render a webpage based on the HTML files from the server for presentation to the user. This disclosure contemplates any suitable webpage files. As an example, and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, the transportation matching system 1202 may be a network-addressable computing system that can host a ride share transportation network. The transportation matching system 1202 may generate, store, receive, and send data, such as, for example, user-profile data, concept-profile data, text data, ride request data, GPS location data, provider data, requester data, vehicle data, or other suitable data related to the ride share transportation network. This may include authenticating the identity of providers and/or vehicles who are authorized to provide ride services through the transportation matching system 1202. In addition, the transportation service system may manage identities of service requestors such as users/requesters. In particular, the transportation service system may maintain requester data such as driving/riding histories, personal data, or other user data in addition to navigation and/or traffic management services or other location services (e.g., GPS services).

In particular embodiments, the transportation matching system 1202 may manage ride matching services to connect a user/requester with a vehicle and/or provider. By managing the ride matching services, the transportation matching system 1202 can manage the distribution and allocation of vehicle subsystem resources and user resources such as GPS location and availability indicators, as described herein.

The transportation matching system 1202 may be accessed by the other components of the network environment 1200 either directly or via network 1204. In particular embodiments, the transportation matching system 1202 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, the transportation matching system 1202 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 1206, or a transportation matching system 1202 to manage, retrieve, modify, add, or delete, the information stored in data store.

In particular embodiments, the transportation matching system 1202 may provide users with the ability to take actions on various types of items or objects, supported by the transportation matching system 1202. As an example, and not by way of limitation, the items and objects may include ride share networks to which users of the transportation matching system 1202 may belong, vehicles that users may request, location designators, computer-based applications that a user may use, transactions that allow users to buy or sell items via the service, interactions with advertisements that a user may perform, or other suitable items or objects. A user may interact with anything that is capable of being represented in the transportation matching system 1202 or by an external system of a third-party system, which is separate from the transportation matching system 1202 and coupled to the transportation matching system 1202 via a network 1204.

In particular embodiments, the transportation matching system 1202 may be capable of linking a variety of entities. As an example, and not by way of limitation, the transportation matching system 1202 may enable users to interact with each other or other entities, or to allow users to interact with these entities through an application programming interfaces (API) or other communication channels.

In particular embodiments, the transportation matching system 1202 may include a variety of servers, sub-systems, programs, modules, logs, and data stores. In particular embodiments, the transportation matching system 1202 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The transportation matching system 1202 may also include suitable components such as network interfaces, security mechanisms, load balancers, failover servers, management-and-network-operations consoles, other suitable components, or any suitable combination thereof. In particular embodiments, the transportation matching system 1202 may include one or more user-profile stores for storing user profiles. A user profile may include, for example, biographic information, demographic information, behavioral information, social information, or other types of descriptive information, such as work experience, educational history, hobbies or preferences, interests, affinities, or location.

The web server may include a mail server or other messaging functionality for receiving and routing messages between the transportation matching system 1202 and one or more client devices 1206. An action logger may be used to receive communications from a web server about a user's actions on or off the transportation matching system 1202. In conjunction with the action log, a third-party-content-object log may be maintained of user exposures to third-party-content objects. A notification controller may provide information regarding content objects to a client device 1206. Information may be pushed to a client device 1206 as notifications, or information may be pulled from the client device 1206 responsive to a request received from the client device 1206. Authorization servers may be used to enforce one or more privacy settings of the users of the transportation matching system 1202. A privacy setting of a user determines how particular information associated with a user can be shared. The authorization server may allow users to opt in to or opt out of having their actions logged by the transportation matching system 1202 or shared with other systems, such as, for example, by setting appropriate privacy settings. Third-party-content-object stores may be used to store content objects received from third parties. Location stores may be used for storing location information received from the client devices 1206 associated with users.

In addition, the vehicle subsystem 1208 can include a human-operated vehicle or an autonomous vehicle. A provider of a human-operated vehicle can perform maneuvers to pick up, transport, and drop off one or more requesters according to the embodiments described herein. In certain embodiments, the vehicle subsystem 1208 can include an autonomous vehicle—i.e., a vehicle that does not require a human operator. In these embodiments, the vehicle subsystem 1208 can perform maneuvers, communicate, and otherwise function without the aid of a human provider, in accordance with available technology.

In particular embodiments, the vehicle subsystem 1208 may include one or more sensors incorporated therein or associated thereto. For example, sensor(s) can be mounted on the top of the vehicle subsystem 1208 or else can be located within the interior of the vehicle subsystem 1208. In certain embodiments, the sensor(s) can be located in multiple areas at once i.e., split up throughout the vehicle subsystem 1208 so that different components of the sensor(s) can be placed in different locations in accordance with optimal operation of the sensor(s). In these embodiments, the sensor(s) can include a LIDAR sensor and an inertial measurement unit (IMU) including one or more accelerometers, one or more gyroscopes, and one or more magnetometers. The sensor suite can additionally or alternatively include a wireless IMU (WIMU), one or more cameras, one or more microphones, or other sensors or data input devices capable of receiving and/or recording information relating to navigating a route to pick up, transport, and/or drop off a requester.

In particular embodiments, the vehicle subsystem 1208 may include a communication device capable of communicating with the client device 1206 and/or the transportation matching system 1202. For example, the vehicle subsystem 1208 can include an on-board computing device communicatively linked to the network 1204 to transmit and receive data such as GPS location information, sensor-related information, requester location information, or other relevant information.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
receiving a first transportation request from a first requestor device associated with a first requestor and a second transportation request from a second requestor device associated with a second requestor;
generating a first route score for a first driving route option that includes a first stop location for the first requestor and a second stop location for the second requestor;
generating a second route score for a second driving route option that includes a coalesced stop location for both the first requestor and the second requestor;
determining to coalesce stop locations based on the first route score and the second route score; and
sending instructions to a transportation provider device associated with a transportation provider in accordance with the second driving route option.

2. The computer-implemented method of claim 1, wherein generating the first route score comprises:
generating, for the transportation provider, a driving score based on a stop for the first requestor at the first stop location and a stop for the second requestor at the second stop location; and
generating, for the first requestor, a walking score based on a first travel metric from a request location to the first stop location or based on a second travel metric from the first stop location to a destination.

3. The computer-implemented method of claim 1, wherein generating the second route score comprises:
generating, for the transportation provider, a driving score based on a coalesced stop for both the first requestor and the second requestor at the coalesced stop location; and
generating, for the first requestor, a walking score based on a third travel metric from a request location to the coalesced stop location or based on a fourth travel metric from the coalesced stop location to a destination.

4. The computer-implemented method of claim 3, wherein generating the second route score further comprises:
applying a coalescing factor that weights the second driving route option based on a number of reduced stop locations compared to the first driving route option.

5. The computer-implemented method of claim 1, wherein the coalesced stop location comprises at least one of:
a pick-up location for both the first requestor and the second requestor;
a pickup location for the first requestor and a drop-off location for the second requestor;
a drop-off location for the first requestor and a pick-up location for the second requestor; or
a drop-off location for both the first requestor and the second requestor.

6. The computer-implemented method of claim 1, further comprising:
determining that the first stop location and the second stop location are within a threshold distance or a threshold estimated time of arrival; and
in response to the determining, generating the second route score that coalesces the first stop location and the second stop location.

7. The computer-implemented method of claim 1, further comprising:
generating, for the first requestor, a set of candidate stop locations for a request location or a destination of the first transportation request, wherein the first stop location is a candidate stop location in the set of candidate stop locations; and
generating a route score for each candidate stop location in the set of candidate stop locations.

8. A system comprising:
at least one processor; and
at least one non-transitory computer-readable storage medium storing instructions that, when executed by the at least one processor, causes the system to:
receive a first transportation request from a first requestor device associated with a first requestor and a second transportation request from a second requestor device associated with a second requestor;
generate a first route score for a first driving route option that includes a first stop location for the first requestor and a second stop location for the second requestor;
generate a second route score for a second driving route option that includes a coalesced stop location for both the first requestor and the second requestor;
determine to coalesce stop locations based on the first route score and the second route score; and
send instructions to a transportation provider device associated with a transportation provider in accordance with the second driving route option.

9. The system of claim 8, further comprising instructions that, when executed by the at least one processor, cause the system to generate the first route score by:
generating, for the transportation provider, a driving score based on a stop for the first requestor at the first stop location and a stop for the second requestor at the second stop location; and
generating, for the first requestor, a walking score based on a first travel metric from a request location to the first stop location or based on a second travel metric from the first stop location to a destination.

10. The system of claim 8, further comprising instructions that, when executed by the at least one processor, cause the system to generate the second route score by:
generating, for the transportation provider, a driving score based on a coalesced stop for both the first requestor and the second requestor at the coalesced stop location; and
generating, for the first requestor, a walking score based on a third travel metric from a request location to the coalesced stop location or based on a fourth travel metric from the coalesced stop location to a destination.

11. The system of claim 10, further comprising instructions that, when executed by the at least one processor, cause the system to generate the second route score by:
applying a coalescing factor that weights the second driving route option based on a number of reduced stop locations compared to the first driving route option.

12. The system of claim 8, wherein the coalesced stop location comprises at least one of:
a pick-up location for both the first requestor and the second requestor;
a pickup location for the first requestor and a drop-off location for the second requestor;
a drop-off location for the first requestor and a pick-up location for the second requestor; or
a drop-off location for both the first requestor and the second requestor.

13. The system of claim 8, further comprising instructions that, when executed by the at least one processor, cause the system to:
determine that the first stop location and the second stop location are within a threshold distance or a threshold estimated time of arrival; and
in response to the determining, generate the second route score that coalesces the first stop location and the second stop location.

14. The system of claim 8, further comprising instructions that, when executed by the at least one processor, cause the system to:
generate, for the first requestor, a set of candidate stop locations for a request location or destination of the first transportation request, wherein the first stop location is a candidate stop location in the set of candidate stop locations; and
generate a route score for each candidate stop location in the set of candidate stop locations.

15. A non-transitory computer-readable storage medium storing instructions that, when executed by the at least one processor, causes a computing device to:
receive a first transportation request from a first requestor device associated with a first requestor and a second transportation request from a second requestor device associated with a second requestor;
generate a first route score for a first driving route option that includes a first stop location for the first requestor and a second stop location for the second requestor;
generate a second route score for a second driving route option that includes a coalesced stop location for both the first requestor and the second requestor;
determine to coalesce stop locations based on the first route score and the second route score; and
send instructions to a transportation provider device associated with a transportation provider in accordance with the second driving route option.

16. The non-transitory computer-readable storage medium of claim 15, further comprising instructions that, when executed by the at least one processor, cause the computing device to generate the first route score by:
generating, for the transportation provider, a driving score based on a stop for the first requestor at the first stop location and a stop for the second requestor at the second stop location; and
generating, for the first requestor, a walking score based on a first travel metric from a request location to the first stop location or based on a second travel metric from the first stop location to a destination.

17. The non-transitory computer-readable storage medium of claim 15, further comprising instructions that, when executed by the at least one processor, cause the computing device to generate the second route score by:
generating, for the transportation provider, a driving score based on a coalesced stop for both the first requestor and the second requestor at the coalesced stop location; and
generating, for the first requestor, a walking score based on a third travel metric from a request location to the coalesced stop location or based on a fourth travel metric from the coalesced stop location to a destination.

18. The non-transitory computer-readable storage medium of claim 17, further comprising instructions that, when executed by the at least one processor, cause the computing device to generate the second route score by:
applying a coalescing factor that weights the second driving route option based on a number of reduced stop locations compared to the first driving route option.

19. The non-transitory computer-readable storage medium of claim 15, wherein the coalesced stop location comprises at least one of:
a pick-up location for both the first requestor and the second requestor;
a pickup location for the first requestor and a drop-off location for the second requestor;
a drop-off location for the first requestor and a pick-up location for the second requestor; or
a drop-off location for both the first requestor and the second requestor.

20. The non-transitory computer-readable storage medium of claim 15, further comprising instructions that, when executed by the at least one processor, cause the computing device to:
determine that the first stop location and the second stop location are within a threshold distance or a threshold estimated time of arrival; and
in response to the determining, generate the second route score that coalesces the first stop location and the second stop location.
